(19) United States
(12) Patent Application Publication
(10) Pub. No.: US 2005/0279310 A1
(43) Pub. Date: Dec. 22, 2005

(54) Intake manifold and manufacturing method thereof

(75) Inventors: Tetsuji Kondo, Tokyo (JP); Mikihiko Suzuki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/138,353

(22) Filed: May 27, 2005

(30) Foreign Application Priority Data
Jun. 16, 2004 (JP) JP2004-177706

(51) Int. Cl. F02M 35/10

(52) U.S. Cl. 123/184.21; 123/336; 123/184.27; 123/184.52

(57) ABSTRACT

The invention provides an intake manifold in which the number of parts or the number of processes of assembling can be reduced, and which is easy to assemble and assuring largely freedom in designing location of an intake control valve. An intake manifold 1 includes a hollow shell 2 and an intake control valve 3 functioning to control a combustion air-intake of an internal combustion engine. The shell 2 is formed by joining integrally a pair of half bodies 2a, 2b having a configuration of the shell 2 being halved in tube axial direction. The intake control valve 3 is built in forming an integral part at the time of joining the half bodies 2a, 2b together.

### BACKGROUND OF THE INVENTION

1. Field of the Invention

The present invention relates to an intake manifold and a manufacturing method thereof.

2. Description of the Related Art

A conventional intake manifold, to correspond to an engine head of a 4-valve engine, includes a shell in which two intake ports are formed with respect to each cylinder of an internal combustion engine respectively; and this shell is provided with an intake control valve functioning to control a combustion air-intake (as disclosed in the Japanese Patent Publication (unexamined) No. 133234/1993).

As for the intake control valve in such a conventional construction, a shaft is located in a direction intersecting a tube axial direction of the intake ports; a butterfly valve is disposed in one side intake port of a pair of intake ports; and this butterfly valve is secured to the shaft with screws. The shaft is driven by an actuator to open and close the butterfly valves, thereby causing a strong swirl to generate at the time of intake, resulting in improvement in combustion characteristics in a combustion chamber of the internal combustion engine, or improvement in torque performance characteristics.

In the conventional intake manifold of this type, a shell thereof is molded into an integral whole using a die, employing aluminum alloy, synthetic resin or the like as material. Accordingly, to attach an intake control valve, it is required to insert and secure a shaft to the shell, and thereafter insert a butterfly valve through an opening of the intake port and screw it to the shaft.

In other words, an intake control valve has been conventionally built in after molding the shell of the intake manifold. Therefore, a shaft and butterfly valves of the intake control valve have to be individually separate parts otherwise they cannot be integrated with the shell. That is, the shaft and butterfly valves need to have been preliminarily formed as separate parts, thus resulting in the larger number of parts and higher manufacturing cost, and being less easy to assemble.

Moreover, it is necessary that positions of screwing are designed so that a screwing tool can be easily inserted when the butterfly valves are screwed to the shaft. Specifically it is essential that the shaft is positioned near to an opening end of the intake port. Thus, a problem exists in that designing is restricted in the aspect of location of an intake control valve being mounted.

### SUMMARY OF THE INVENTION

The present invention was made in view of the above-mentioned problems, and has an object of providing an intake manifold with which the number of parts or the number of assembling processes can be reduced, which is easy to assemble, and further which provides a sufficient freedom in designing location of an intake control valve being mounted. The invention also provides a manufacturing method of such an intake manifold.

To accomplish the foregoing objects, an intake manifold according to the present invention includes an intake control valve that controls a combustion air-intake of an internal combustion engine. In the intake control valve, a shaft is disposed in a direction getting across a passage direction of a shell forming a combustion air passage, and a butterfly valve functioning to open and close the mentioned combustion air passage is disposed on the shaft.

In the intake manifold according to the invention, the mentioned shell is formed by joining together a pair of half bodies having a configuration of the shell being halved in a tube axial direction; and the mentioned intake control valve is integrally built in when the mentioned half bodies are joined together.

A manufacturing method of an intake manifold according to the invention includes the steps of preliminarily molding a pair of half bodies having a configuration of being halved in a tube axial direction; building the mentioned intake control valve in so that the mentioned butterfly valve is interposed on a combustion air passage, and that the mentioned shaft is sandwiched between two half bodies; and joining integrally composition faces of the half bodies to form a shell.

According to the invention, since an intake control valve in which a shaft and a butterfly valve are integrally formed can be used, reduction in the number of parts and reduction in the number of assembling processes are both achieved. Furthermore, since it is unnecessary to take into consideration efficiency for insertion and working of a screwing tool, freedom in designing location of an intake control valve comes to be improved. Further, even in the case of employing an intake control valve in which a shaft and a butterfly valve are separately formed as in the conventional intake control valve, the butterfly valve can be attached to the shaft before the intake control valve is built in the intake manifold. Therefore, there is no restriction in insertion of a screwing tool, thus making it easy to assemble. Further, since supports of the shaft that are provided at the half bodies can be made in a semicircular shape in conformity with a contour of the shaft, it is possible for the intake control valve to be easily mounted.

The foregoing and other object, features, aspects and advantages of the present invention will become more apparent the following detailed description of the present invention when taken in conjunction with the accompanying drawings.

### BRIEF DESCRIPTION OF THE DRAWINGS

FIG. 1 is a perspective view of an intake manifold having an intake control valve according to a first preferred embodiment of the present invention.

FIG. 2 is a side view taken in the direction of the arrow A of FIG. 1.

FIG. 3 is a cross sectional view taken along the line B-B of FIG. 2.

FIG. 4 is a perspective view of an intake control valve.

FIG. 5 is a perspective view showing the state in which an intake control valve is set on one of half bodies before the half bodies of the intake manifold are joined together.

FIG. 6 is a perspective view showing the state in which an intake control valve is set on one of half bodies before the half bodies are joined together in an intake manifold including an intake control valve according to a second embodiment of the invention.

FIG. 7 is a partially enlarged cross sectional view taken at the plane C through a center of a shaft of FIG. 6.

FIG. 8 is a partially enlarged perspective view showing the state in which an intake control valve is set on one of half bodies before the half bodies are joined together in an intake manifold including an intake control valve according to a third embodiment of the invention.

FIG. 9 is a partially enlarged cross sectional view taken at the plane D through a center of a shaft of FIG. 8.

### DESCRIPTION OF THE PREFERRED EMBODIMENTS

### Embodiment 1

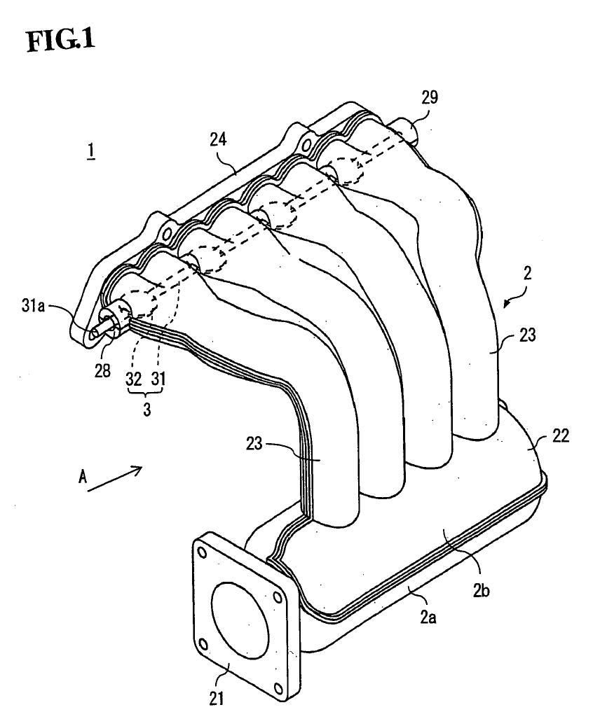

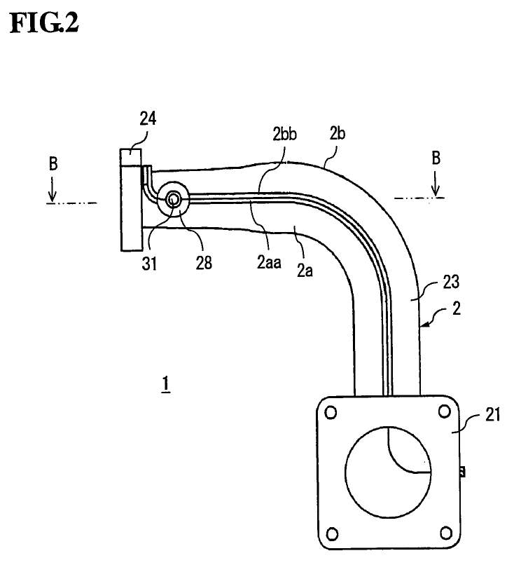

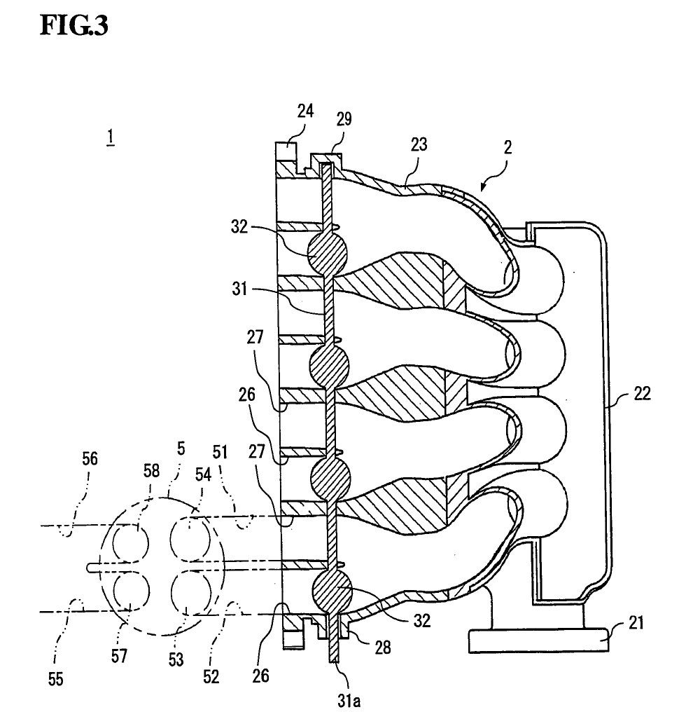

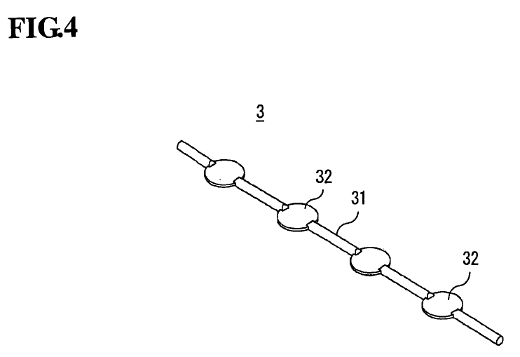

FIG. 1 is a perspective view of an intake manifold having an intake control valve according to a first preferred embodiment of the invention; FIG. 2 is a side view taken in the direction of the arrow A of FIG. 1; FIG. 3 is a cross sectional view taken along the line B-B of FIG. 2; and FIG. 4 is a perspective view of an intake control valve.

Referring now to FIGS. 1 to 4, an intake manifold having an intake control valve according to a first preferred embodiment of the present invention is hereinafter described.

An intake manifold 1 according to this first embodiment is mounted onto an engine head of the so-called four-valve engine in which four valves are disposed with respect to cylinders of an internal combustion engine. The intake manifold 1 includes a hollow shell 2.

This shell 2 is made of a synthetic resin such as nylon in consideration of heat resistance, strength, and cost. In the shell 2, there are provided a flange 21 for mounting the shell 2 onto a throttle body, not shown, a surge tank 22, and four pipelines 23 in an internal part of which combustion air passages with respective to respective cylinders of an internal combustion engine are integrally formed. Further, this shell 2 is provided with an intake control valve 3 functioning to control a combustion air-intake. A leading end portion of each pipeline 23 of the shell 2 is bifurcated to form intake ports 26, 27 in the internal part thereof. Furthermore, a flange 24 for mounting the shell 2 onto the engine head is formed as an integral part at distal ends of points where respective intake ports 26, 27 are formed.

Each of the intake ports 26, 27 is open to each cylinder 5 of the internal combustion engine via intake ports 51, 52 that are provided at an engine head. The intake ports 51, 52 are provided with intake valves 53, 54 respectively. In addition, reference numerals 55, 56 designate two exhaust ports that are formed at the engine head. Respective exhaust ports 55, 56 are provided with exhaust valves 57, 58 individually.

The above-mentioned intake control valve 3 is made of a synthetic resin such as nylon, and includes butterfly valves 32 that are integrally formed at a predetermined pitch along the axial direction of a shaft 31. In this regard, the intake control valve 3 may be made of not only synthetic resin but also metal. The shaft 31 of the intake control valve 3 is disposed passing through the shell 2 in a direction getting across a tube axial direction of the intake ports 26, 27. Two ends of the shaft 31 are supported rotatably with cylindrical supports 28, 29 that are formed at the lateral ends of the shell 2. One end of the shaft 31 protrudes outward from the shell 2, and an actuator, not shown, acting to bring the shaft 31 in rotation is connected to a protrusion 31a thereof.

Each butterfly valve 32 is positioned in the intake port 26, being one side of a pair of the intake ports 26, 27, and acts to open and close this intake port 26 in accordance with the rotation of the shaft 31. In this case, the intake port 26 in which the butterfly valve 32 is disposed is used as a high-speed side intake port; and the other intake port 27 in which no butterfly valve 32 is disposed is used as a low-speed side intake port.

Now, operations of the intake manifold that is provided with the above-mentioned intake control valve 3 are hereinafter described.

Opening and closing of the butterfly valve 32 that is disposed in the intake port 26, being one side of a pair of the intake ports 26, 27, are controlled by an actuator, not shown. That is, under the conditions of a small engine load and a strong swirl being required at the moment of intake air, for example, during idling operation, the butterfly valve 32 is fully closed. In this state, a total cross section of the intake ports 26, 27 comes to be smaller, so that it is possible to keep a high intake flow rate, thereby ensuring good combustion in the cylinder 5 or good torque performance.

On the other hand, in the case of a large engine load, the butterfly valve 32 is fully open. In this state, a total cross section of the intake ports 26, 27 comes to be larger, thus making it possible to introduce air into the cylinder 5 of the engine simultaneously from both of the intake ports 26, 27 for low speed and high speed. Due to the increase in air-intake, it is possible to obtain a high power. By controlling opening and closing the butterfly valve 32 in this manner, good torque performance at low and medium speeds is maintained, and high power is ensured in a range of high speed.

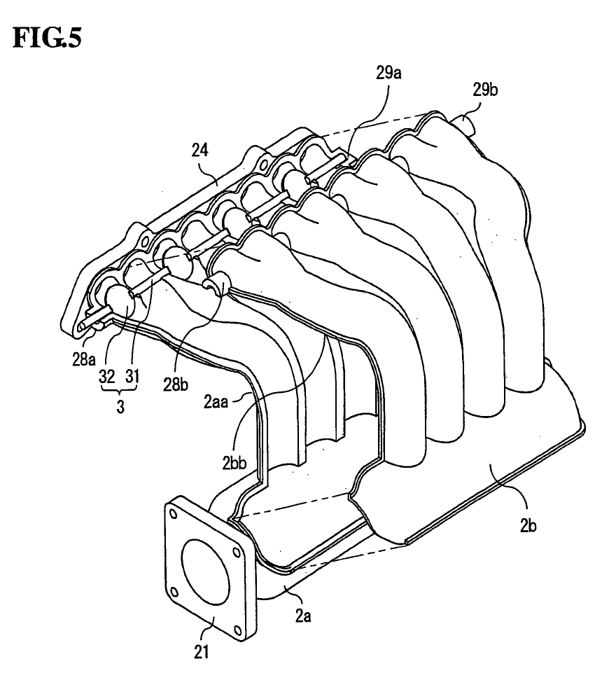

Now, a manufacturing method of the intake manifold 1 of the above-mentioned construction is hereinafter described with reference to FIG. 5.

First, a pair of half bodies 2a, 2b having a configuration halved in a tube axial direction are injection-molded with the use of a die. Then, an intake control valve 3 is set on the half body 2a, being one of a pair, before joining the half bodies 2a, 2b together. At this time, the shaft 31 is located so that both ends thereof are supported on the semi-cylindrical supports 28a, 28b that are formed at lateral ends of one half body 2a.

Subsequently, joint grooves 2aa, 2bb having been formed preliminarily along a periphery of butt portions of both of the half bodies 2a, 2b are filled with molten resin under the conditions that both half bodies 2a, 2b are in the butt state. By this process, butt portions of the half bodies 2a, 2b are joined integral with each other to be formed into a single shell provided with the intake control valve 3.

According this manufacturing method, the supports 28a, 28b, 29a, 29b of the shaft which supports are provided at lateral ends of the half bodies 2a, 2b can be formed in a semi-cylindrical configuration that is halved in plane through a center of the shaft 31 so as to be in conformity with a contour of the shaft 31. Consequently, it is possible for the intake control valve 3 to be easily built in, thus enabling to reduce the number of assembling processes. Further, even in the case of the intake control valve 3 in which the shaft 31 and the butterfly valve 32 are integrally formed, it is possible for the intake control valve 3 to be easily integrated into a shell. Thus, it is unnecessary for a shaft 31 and a valve 32 to be individual separate parts unlike the conventional structure, thereby enabling to achieve the reduction in the number of parts.

As a specific example of the method of forming such half bodies 2a, 2b, and joining the half bodies 2a, 2b together as a series of molding processes, for example, die slide injection (hereinafter, it is referred to as DSI) is preferably employed. Used in this DSI method is a molding apparatus provided with one die that is formed of a male-type molding part and a female-type molding part acting to mold a set of half bodies 2a, 2b, and the other die that is formed of a female-type molding part and a male-type molding part opposed to the molding parts of one die respectively.

Respective half bodies 2a, 2b are injection-molded simultaneously by using such a molding apparatus. Thereafter, the intake control valve 3 is integrally built in the half body 2a, being one of the half bodies left in each female molding part. Subsequently, one of the dies is made to slide with respect to the other die, whereby the half bodies 2a, 2b having been left in respective female molding parts are brought in butt to each other. Then, a molten resin is injected into joint grooves 2aa, 2bb at the periphery of these butt portions to join both half bodies 2a, 2b. In this joining, the step of filling the above-mentioned joint grooves 2aa, 2bb with molten resin is performed in the dies for molding the half bodies 2a, 2b.

### Embodiment 2

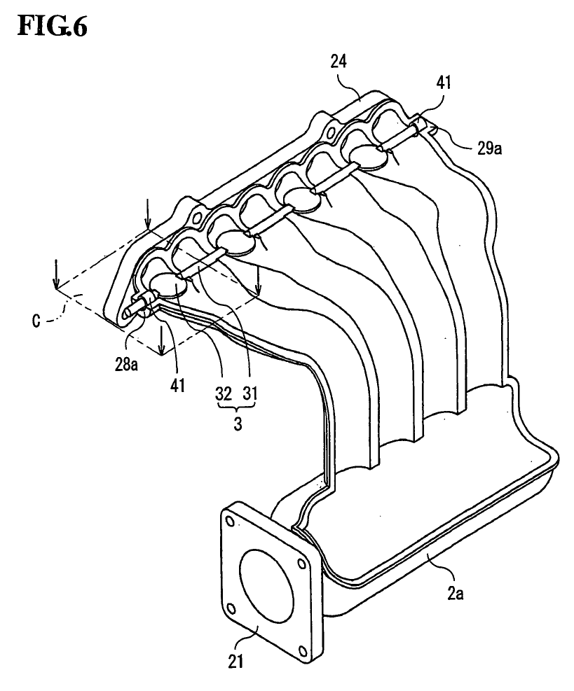

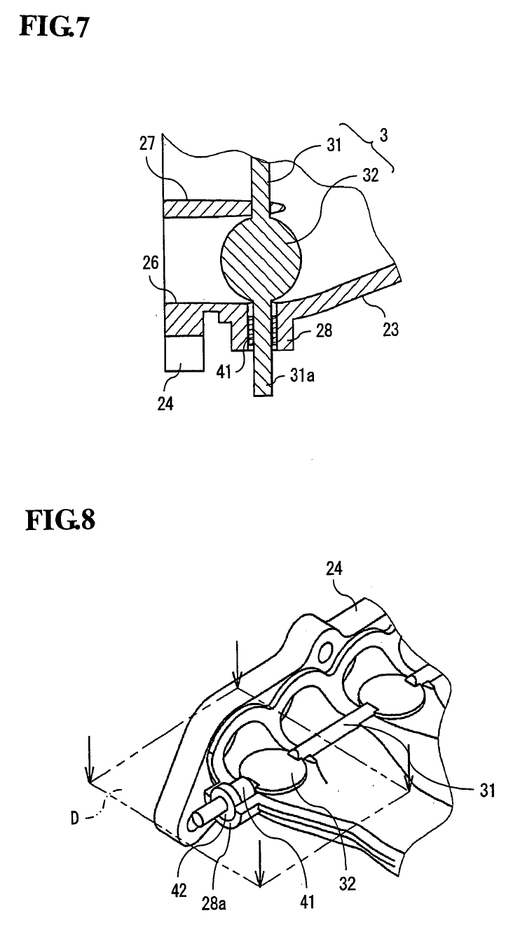

FIG. 6 is a perspective view showing a state in which an intake control valve is set on one of the half bodies before joining the half bodies together in an intake manifold having an intake control valve according to a second embodiment of the invention. FIG. 7 is a partially enlarged cross sectional view taken at the plane C through a center of a shaft 31 of FIG. 6. The same reference numerals indicate components corresponding to those of the foregoing first embodiment shown in FIGS. 1 through 5.

Features of the intake manifold according to this second embodiment consist in that bearings 41 are disposed in the cylindrical-shaped supports 28, 29 that are formed at the lateral ends of the shell 2 respectively, and that both ends of the shaft 31 are inserted through each bearing 41 to be supported rotatably with the bearings 41. As a material of the bearing 41, any hard resin such as Teflon (trade mark) or metal can be used. In this example, when the intake control valve 3 is set on the supports 28a, 29a of the half body 2a, being one of a pair to join the half bodies 2a, 2b together, each end portion of the shaft 31 is preliminarily inserted through the bearings 41.

In this manner, due to the fact that both ends of the shaft 31 of the intake control valve are supported with the bearings 41, it is possible to make further smaller a running torque of the shaft 31 being driven by an actuator, not shown, thereby enabling to diminish load on the actuator. Although the bearings 41 are provided at only two points of both ends of the shaft, it is more desirable that they are provided further at the other contact points of the shell 2.

The other constructions are the same as in the foregoing first embodiment shown in FIGS. 1 through 5. In addition, a manufacturing method of the intake manifold according to this second embodiment is basically the same as in the foregoing first embodiment except that each end portion of the shaft 31 has been preliminarily inserted through the bearings 41, so that further detailed descriptions are herein omitted.

### Embodiment 3

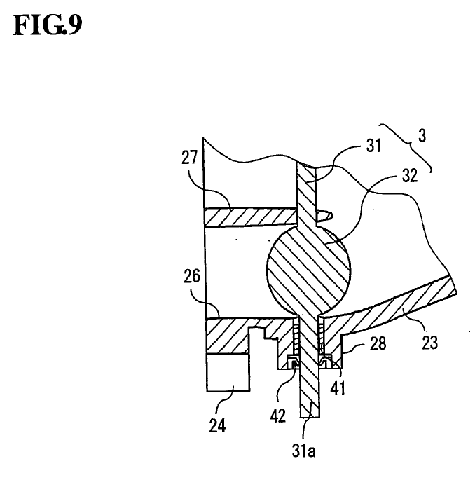

FIG. 8 is a partially enlarged perspective view showing a state in which an intake control valve is set on one of the half bodies before joining the half bodies together in an intake manifold having an intake control valve according to a third embodiment of the invention. FIG. 9 is a partially enlarged cross sectional view taken at the plane D through a center of a shaft of FIG. 8. The same reference numerals refer to components corresponding to those of the foregoing first embodiment shown in FIGS. 1 through 5.

In the same manner as in the foregoing second embodiment, features of the intake manifold according to the third embodiment consist in that bearings 41 are provided in the cylindrical-shaped supports 28, 29 that are formed in lateral ends of shell 2, and that both ends of the shaft 31 are rotatably supported with each bearing 41. According to this third embodiment, one end of the shaft 31 of the intake control valve 3 is protruding outward from the shell 2 for the purpose of connecting the shaft 31 to an actuator, not shown, functioning to bring the shaft 31 in rotation and, furthermore, a seal member 42 made of, e.g., rubber is disposed in order to seal a gap between a protrusion 31a and the shell 2.

In the case of protruding one end of the shaft 31 of the intake control valve 3 outward from the shell 2 in order to connect the shaft 31 to the actuator serving to bring the shaft 31 in rotation, a slight gap will be formed between the shaft 31 and the support 28 of the shell. There is the possibility that outside air, water, foreign particles and the like could flow through this gap into an internal part of the pipeline 23, eventually resulting in undesirable effects on the internal combustion engine. Therefore, according to this third embodiment, a seal member 42 is disposed in a gap between the protrusion 31a of the shaft 31 and the shell 2 to keep the shell 2 airtight, whereby it is possible to prevent water, foreign particles and the like, which are harmful to an internal combustion engine, from getting in. In addition, mounting the seal member 42 may be done in either process at the time of joining the half bodies 2a, 2b together or after having joined the half bodies 2a, 2b.

The other constructions are the same as in the foregoing first embodiment shown in FIGS. 1 through 5. A manufacturing method of the intake manifold according to this third embodiment is also basically the same as in the foregoing first embodiment, so that further detailed descriptions are herein omitted.

Additionally, according to the above-described first to third embodiments, an intake control valve 3 in which a shaft 31 and a butterfly valve 32 are integrally molded is described. However, it is also possible to employ such a structure in which the shaft 31 and the butterfly valve 32 are individual separate parts, and both parts 31, 32 are secured with screws in the like manner to the conventional art. Even in this structure, since the butterfly valve 32 can be attached to the shaft 31 easily before the intake control valve 3 is built into the shell 2, there is no restriction in insertion of a screwing tool, thus assembling becomes easy.

Moreover, according to the manufacturing methods of the above-mentioned intake manifolds according to the first to third embodiments, the case of employing DSI as a specific example of the method of joining the half bodies to each other is described. The present invention is, however, not limited to this DSI, and any other manufacturing method such as vibration welding is also applicable.

That is, the vibration welding is applied, after the intake control valve 3 is integrated into the half body 2a, being one of a pair, and each of the half bodies 2a, 2b made of synthetic resin have been injection-molded. By this vibration welding, the half bodies 2a, 2b are brought in butt; the butt portions are made to slightly vibrate while applying a pressure; and the butt portions of the half bodies 2a, 2b are fused with a frictional heat generated by this vibration, thereby joining both of them together to obtain an integral shell.

The intake control valve 3 that is integrated into an intake manifold according to the invention is described above on the supposition that a swirl control valve that generates a strong swirl at the time of intake air for the purpose of improving combustion in a combustion chamber of the engine, torque performance or the like. However, the invention is not limited to this swirl control valve, and the invention is applicable, for example, to a variable intake pipe length control valve that is disposed on the way of an intake pipeline and that controls an intake pipe length depending on an engine speed in order to obtain inertia supercharging effect.

While the presently preferred embodiments of the present invention have been shown and described. It is to be understood that these disclosures are for the purpose of illustration and that various changes and modifications may be made without departing from the scope of the invention as set forth in the appended claims.

1. An intake manifold comprising an intake control valve that controls a combustion air-intake of an internal combustion engine; and in said intake control valve, a shaft is disposed in a direction getting across a passage direction of a shell forming a combustion air passage, and a butterfly valve functioning to open and close said combustion air passage is disposed on said shaft;
wherein said shell is formed by joining together a pair of half bodies having a configuration of the shell being halved in a tube axial direction; and said intake control valve is integrally built in when said half bodies are joined together.

2. The intake manifold according to claim 1, wherein the shaft and the butterfly valve that form said intake control valve are formed into an integral whole.

3. The intake manifold according to claim 1, wherein a bearing is provided at a contact portion between said shaft and shell.

4. The intake manifold according to claim 1, wherein a gap between a protrusion formed by protruding a part of said shaft outward from the shell and said shell is sealed with a seal member.

5. A manufacturing method of an intake manifold provided with an intake control valve that controls a combustion air-intake of an internal combustion engine; and in said intake control valve, a shaft is disposed in a direction getting across a passage direction of a shell forming a combustion air passage, and a butterfly valve functioning to open and close said combustion air passage is disposed on said shaft;
the method comprising the steps of: preliminarily molding a pair of half bodies having a configuration of being halved in a tube axial direction; building said intake control valve in so that said butterfly valve is interposed on a combustion air passage, and that said shaft is sandwiched between two half bodies; and joining integrally composition faces of the half bodies to form a shell.

6. The manufacturing method of an intake manifold according to claim 5, wherein joining the half bodies in which said intake control valve has been built is performed by filling joint grooves that are formed along a periphery of butt portions of respective half bodies with fused resin.

7. The manufacturing method of an intake manifold according to claim 5, wherein joining the half bodies in which said intake control valve has been built is performed by vibration welding in which butt portions of respective half bodies are vibrated while applying a pressure and fused.
